(19) United States
(12) Patent Application Publication
(10) Pub. No.: US 2006/0236386 A1
(43) Pub. Date: Oct. 19, 2006

(54) Method and apparatus for cooperative file distribution in the presence of firewalls

(76) Inventor: Laird Alexander Popkin, West Orange, NJ (US)

Correspondence Address: Ryan, Mason & Lewis, LLP;Suite 205, 1300 Post Road, Fairfield, CT, 06824, US

(21) Appl. No.: 11/096,194

(22) Filed: Mar. 31, 2005

(51) Int. Cl. G06F 15/16

(52) U.S. Cl. 726/12

(57) ABSTRACT

Methods and apparatus are provided for cooperative file distribution system employing one or more firewall proxies to allow users behind a firewall to exchange files or pieces thereof via the firewall proxies. A central tracker receives an indication from a sender that the sender has a file for a receiver. If both the sender and receiver are behind a firewall, the tracker obtains a list of potential firewall proxies for transferring the file from the sender to the receiver; and initiates a transfer of the file from the sender to the receiver using one or more of the potential firewall proxies. The potential firewall proxies may be identified, for example, by a proxy service. The firewall proxies are not behind firewalls and satisfy one or more predefined resource criteria.

### CROSS REFERENCE TO RELATED APPLICATIONS

The present application is related to U.S. patent application Ser. No. ______, entitled “Method And Apparatus For Offline Cooperative File Distribution Using Cache Nodes,” filed contemporaneously herewith and incorporated by reference herein.

### FIELD OF THE INVENTION

The present invention relates generally to communication methods and systems, and more particularly, to cooperative methods and systems for sharing one or more files among users.

### BACKGROUND OF THE INVENTION

The providers of popular, large digital files, such as software, music or video files, must keep pace with the ever increasing bandwidth demands for delivering such files. As the popularity of a file increases, a larger number of users are requesting the file and more bandwidth is required to deliver the file. With conventional Hypertext Transfer Protocol (HTTP) file delivery techniques, for example, the bandwidth requirements increase linearly with the number of requesting users, and quickly becomes prohibitively expensive.

A number of techniques have been proposed or suggested for reducing the bandwidth demands of file delivery on the server, using peer-to-peer content sharing. In a peer-to-peer content sharing model, often referred to as “cooperative distribution,” one or more users that have downloaded a file from the server can share the file with other users. A cooperative distribution model allows a server to deliver large files in a reliable manner that scales with the number of requesting users. Among other benefits, cooperative distribution models exploit the underutilized upstream bandwidth of existing users.

The BitTorrent™ file distribution system, described, for example, in http://www.bittorrent.com/documentation.html, or Bram Cohen, “Incentives Build Robustness in BitTorrent,” http://www.bittorrent.com/bittorrentecon.pdf (May 22, 2003) is an example of a cooperative distribution technique. When multiple users are downloading the same file at the same time using the BitTorrent file distribution system, the various users upload pieces of the file to each other. In other words, a BitTorrent user trades pieces of a file that the user has with other required pieces that other users have until the complete file is obtained. In this manner, the cost of uploading a file is redistributed to the users of the file and the cost of hosting a popular file is more affordable.

While the BitTorrent file distribution system provides an effective mechanism for distributing large files in a cost effective manner, it suffers from a number of limitations, which if overcome, could further improve the utility and efficiency of cooperative file distribution. In particular, if two BitTorrent users are behind a firewall, then they cannot negotiate a connection with each other and are unable to share files.

A need therefore exists for a cooperative file distribution system that allows users behind a firewall to exchange files or pieces thereof. A further need exists for a cooperative file distribution system that employs one or more firewall proxies to allow users behind a firewall to exchange files or pieces thereof via the firewall proxies.

### SUMMARY OF THE INVENTION

Generally, methods and apparatus are provided for cooperative file distribution system employing one or more firewall proxies to allow users behind a firewall to exchange files or pieces thereof via the firewall proxies. According to one aspect of the invention, a central tracker receives an indication from a sender that the sender has a file for a receiver. If both the sender and receiver are behind a firewall, the tracker obtains a list of potential firewall proxies for transferring the file from the sender to the receiver; and initiates a transfer of the file from the sender to the receiver using one or more of the potential firewall proxies. The potential firewall proxies may be identified, for example, by a proxy service. The firewall proxies are not behind firewalls and satisfy one or more predefined resource criteria.

According to another aspect of the invention, a sender receives a list of potential firewall proxies for transferring the file to the receiver; sends a request to one or more of the firewall proxies from the list of firewall proxies to act as a firewall proxy between the sender and the receiver; and transfers the file from the sender to the one or more of the potential firewall proxies. A receiver in accordance with the present invention receives a notification of one or more firewall proxies storing at least a portion of the file; and obtains the at least a portion of the file from the one or more firewall proxies.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating a conventional BitTorrent file distribution system;

FIG. 2 is a schematic block diagram of a cooperative file distribution system incorporating features of the present invention;

FIG. 3 is a communication sequence diagram in accordance with a Unified Modeling Language (UML) notation, illustrating the communications and other processing performed by the various entities of FIG. 2;

FIG. 4 is a flow chart describing an exemplary implementation of a bit torrent initiation process, as performed by the firewall routing tracker of FIG. 2;

FIG. 5 is a flow chart describing an exemplary implementation of a firewall proxy selection process, as performed by the proxy service of FIG. 2; and

FIG. 6 is a flow chart describing an exemplary implementation of a firewall proxy availability process that is implemented by a potential firewall proxy 260 and incorporates features of the present invention.

### DETAILED DESCRIPTION

The present invention provides a cooperative file distribution system that employs one or more firewall proxies to allow users behind a firewall to exchange files or pieces thereof via the firewall proxies. Generally, the firewall proxies are not behind firewalls, and thus the sender and receiver of a file can establish a connection to one or more firewall proxies.

### BitTorrent Framework

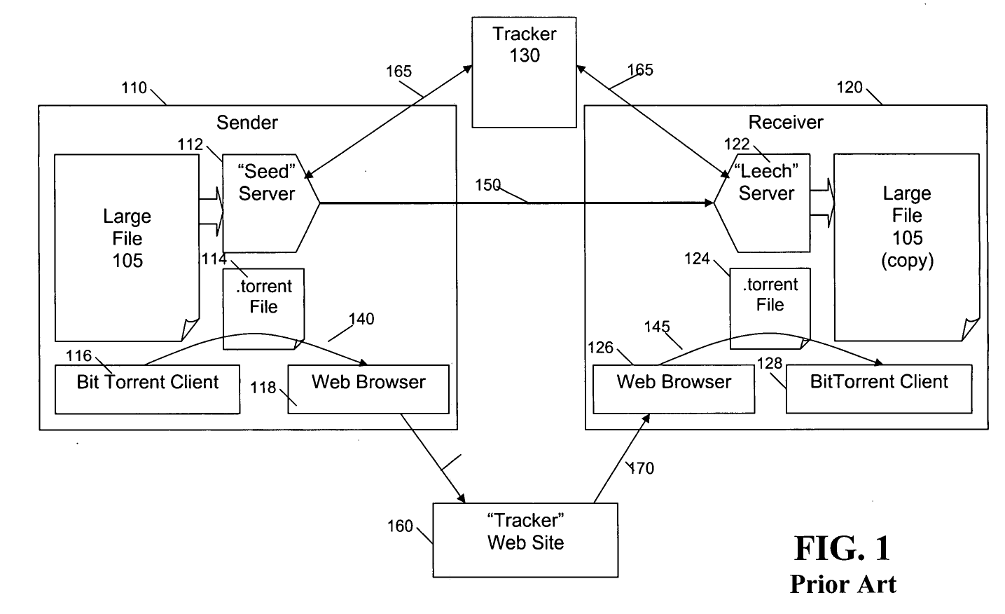

FIG. 1 is a schematic block diagram illustrating a conventional BitTorrent file distribution system 100. As shown in FIG. 1, a sender 110, desiring to send one or more large files 105 to a receiver 120, interacts with a tracker 130 that is part of the BitTorrent file distribution system 100. For a more detailed discussion of the BitTorrent file distribution system 100, see, for example, BitTorrent Protocol, http://www.bittorrent.com/protocol.html, or BitTorrent Guide, http://www.bittorrent.com/guide.html, each incorporated by reference herein.

Generally, to publish one or more files 105 using the BitTorrent file distribution system 100, a corresponding static file 114 with extension .torrent is put on a web server 160. In particular, as shown in FIG. 1, a BitTorrent client 116 executing on the sender computing device 110 typically initiates a web browser 118, for example, via a manual post 140, to place the torrent file 114 on the BitTorrent web server 160. Alternatively, the torrent file 114 can be sent by email to the receiver 120. The web browser 118 communicates with the BitTorrent web server 160, for example, by means of conventional HTTP communications 170. The .torrent file 114 contains information about the file, including its length, name, and hashing information, and the web address (e.g., a URL) of a tracker 130. Trackers 130 are responsible for helping users find each other.

Trackers 130 communicate using a protocol that may be layered on top of HTTP in which a downloader 110, 120 sends information regarding the one or more files that the user is downloading, the port that the user is listening on, and similar information, and the tracker 130 responds with a list of contact information for peers that are downloading the same file. Downloaders 110, 120 then use this information to connect with one another.

To make one or more files 105 available, a downloader 110 having the complete file(s) 105 initiates a seed server 112, using the BitTorrent client 116. The bandwidth requirements of the tracker 130 and web server 160 are low, while the seed must send out at least one complete copy of the original file.

The responsibilities of the tracker 130 are generally limited to helping peers (i.e., users) find each other. Typically, the tracker 130 returns a random list of peers to each user. In order to keep track of the files and file pieces held by each user 110, 120, the BitTorrent file distribution system 100 divides files into pieces of fixed size, typically a quarter megabyte. Each downloader 110, 120 reports to all of its peers via the tracker 130, the pieces held by the respective downloader 110, 120. Generally, each peer sends bit torrent tracker messages 165 to the tracker 130. To verify data integrity, a hash of each piece can be included in the .torrent file 114, and a given peer does not report that it has a given piece until the corresponding hash has been validated.

On the receiver side 120, the receiver 120 reads the web page on the tracker web site 160 with .torrent file 114 attached and uses the browser 126 to click on the .torrent file. As a result, the BitTorrent client 128 is launched on the receiver 120 and the .torrent file 124 is provided to the client process 128. In addition, the BitTorrent client 128 initiates a “Leech” server 122 that allows the receiver 120 to connect to the public tracker 130. In this manner, the file 105 is sent from the “seed” 112 to the “leech” 122 via connection 150, such as an offline peer-to-peer connection or swarm delivery, in a known manner. The file copy 105 can then be opened by the receiver 120, for example, using an operating system function.

### Offline Cooperative File Distribution

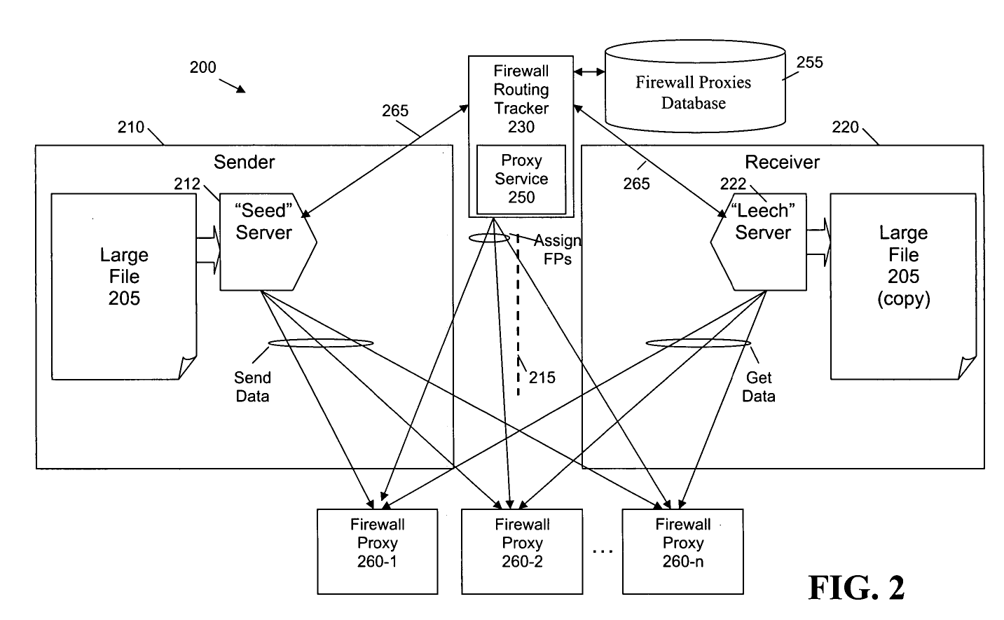

As previously indicated, if two BitTorrent users, such as the sender 110 and receiver 120, are behind a firewall 215, then the users 110, 120 cannot negotiate a connection with each other and are unable to share files. The present invention provides a cooperative file distribution system 200, shown in FIG. 2, that employs one or more firewall proxies 260-1 through 260-n (hereinafter, collectively referred to as firewall proxies 260) to allow users 210, 220 behind a firewall 215 to exchange files or pieces thereof via the firewall proxies 260. Generally, the firewall proxies 260 are not behind firewalls, and thus the sender 210 and receiver 220 of a file can each establish a connection to one or more firewall proxies 260 to exchange the file or file piece.

FIG. 2 is a schematic block diagram of a cooperative file distribution system 200 incorporating features of the present invention. The present invention thus uses nodes that are not behind a firewall 215 to proxy communications between two nodes 210, 220. In other words, since both sender 210 and receiver 220 can communicate with the proxies 260, the sender 210 can deposit blocks of data into the proxy nodes 260, and the receiver 220 can retrieve that data from the firewall proxies 260. Typically, this data will only be retained briefly in memory by the firewall proxies 260, and will not be stored onto the disk memory of the proxy node 260, so the privacy of the communications is preserved. In one exemplary implementation, a large number of nodes serve as firewall proxies 260 in order to minimize the impact on each node 260, and to make the overall data exchange as robust as possible.

The cooperative file distribution system 200 may be implemented, for example, using the BitTorrent file distribution system 100 of FIG. 1, as modified herein to provide the features and functions of the present invention. As discussed hereinafter, the cooperative file distribution system 200 includes a firewall routing tracker 230 that may be implemented using the tracker 130 of the BitTorrent file distribution system 100 of FIG. 1, as modified herein to provide the features and functions of the present invention.

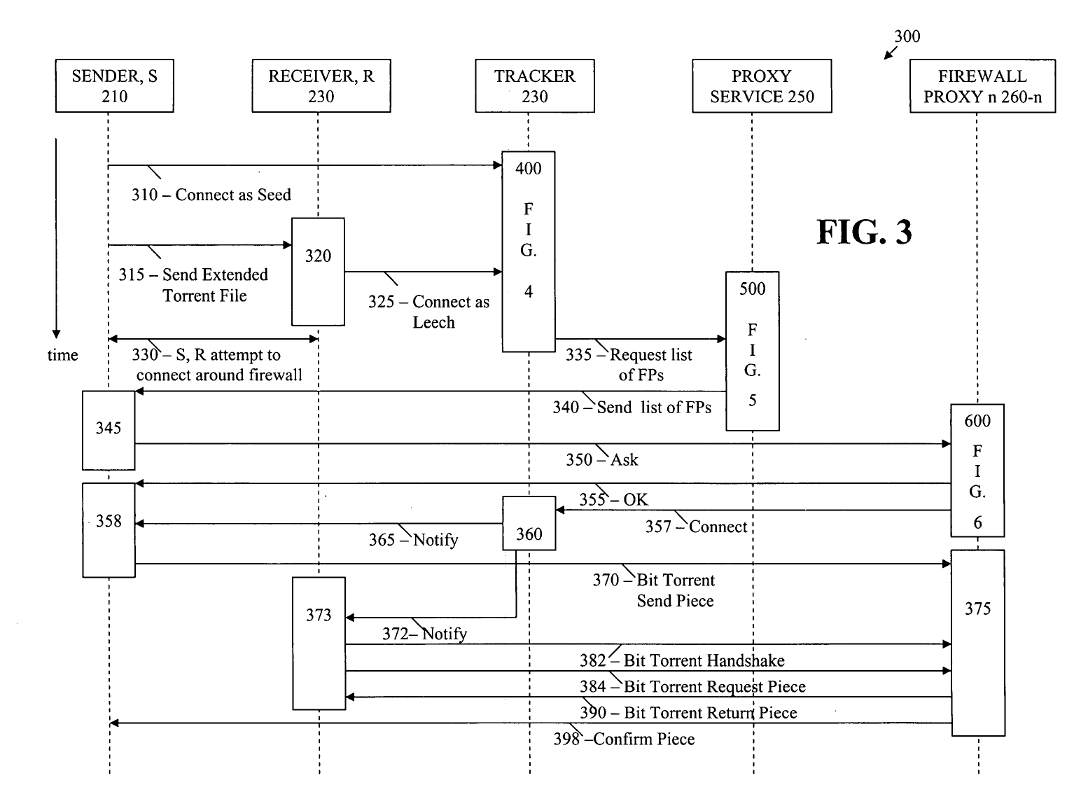

In addition as discussed further below in conjunction with FIG. 3, the cooperative file distribution 200 employs a proxy service 250 to identify nodes that are available to serve as firewall proxies 260. The proxy service 250 may be integrated with the firewall routing tracker 230, as shown in FIG. 2, or may be a stand-alone device, as would be apparent to a person of ordinary skill in the art. The proxy service 250 may employ, for example, a firewall proxies database 255 that identifies the nodes that are available to serve as firewall proxies 260. For each potential firewall proxy 260, the exemplary firewall proxies database 255 indicates whether the node is behind a firewall, and provides a measure of the idleness, available disk space, available bandwidth, and the likelihood that the node is online (e.g., network persistence or a characterization of whether the node is transient or permanent). In addition, the firewall proxies database 255 optionally provides information on the operating system employed by the node and the current IP address of the node. The firewall proxies database 255 is optionally indexed by a global unique identifier (GUID), in a known manner.

The exemplary profile information maintained in the firewall proxies database 255 may be obtained, for example, by a profile service that can be integrated with, or independent of, the proxy service 250. For example, the profile service may obtain information directly from each potential firewall proxy 260 regarding the state of the node (e.g., whether the node is behind a firewall) and its resources. In addition, in a further variation, after a given receiver 220 has received a file or a portion thereof from a given firewall proxy 260, the receiver 220 can provide a confirmation report to the profile service. In this manner, the validating information from the receivers 220 reduces the likelihood of abuse by the firewall proxies 260.

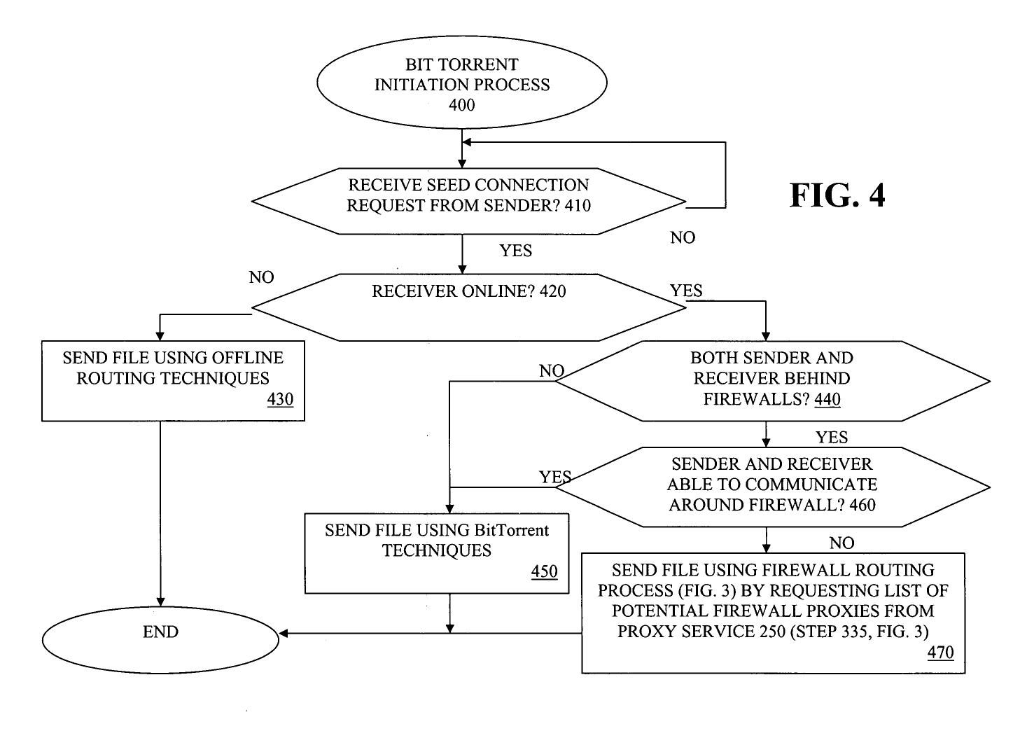

FIG. 3 is a communication sequence diagram 300 in accordance with a Unified Modeling Language (UML) notation, illustrating the communications and other processing performed by the various entities of FIG. 2. As shown in FIG. 3, the communication sequence 300 is initiated during step 310 by the sender 210 connecting to the tracker 230 as a seed. Generally, the seed connection request 310 indicates to the tracker 230 that the sender has the complete file 205. The seed connection request 310 may be triggered, for example, by the sender's client upon attaching a document to an email or sending an email with an attachment. The seed connection request 310 is received by the tracker 230 and processed in a manner discussed further below in conjunction with FIG. 4.

In addition, the sender 210 sends an extended .torrent file to the receiver 220 during step 315. Generally, the extended .torrent file is based on the torrent file 114 that contains information about the file, including its length, name, and hashing information for file validation, and the web address (e.g., a URL) of the tracker 230. The extended .torrent file also optionally contains an encryption key, and metadata, such as a preview and other file information. It is noted that each distinct file has a unique torrent identifier that is included in the .torrent file, for example, as an argument of the address of the tracker 230.

The receiver 220 receives and processes the extended .torrent file during step 320. Generally, during step 320, the receiver 220 clicks on the extended .torrent file, thereby launching a BitTorrent client and leech server 222 on the receiver 220. The leech server 222 sends a leech connection request to the firewall routing tracker 230 during step 325.

Upon receiving the seed and leech connection requests 310, 325 from the sender 210 and receiver 220, respectively, the firewall routing tracker 230 will process the file transfer using a bit torrent initiation process 400, as discussed further below in conjunction with FIG. 4. Generally, the bit torrent initiation process 400 processes the seed and leech connection requests 310, 325 from the sender 210 and receiver 220 and determines how to best process the file transfer.

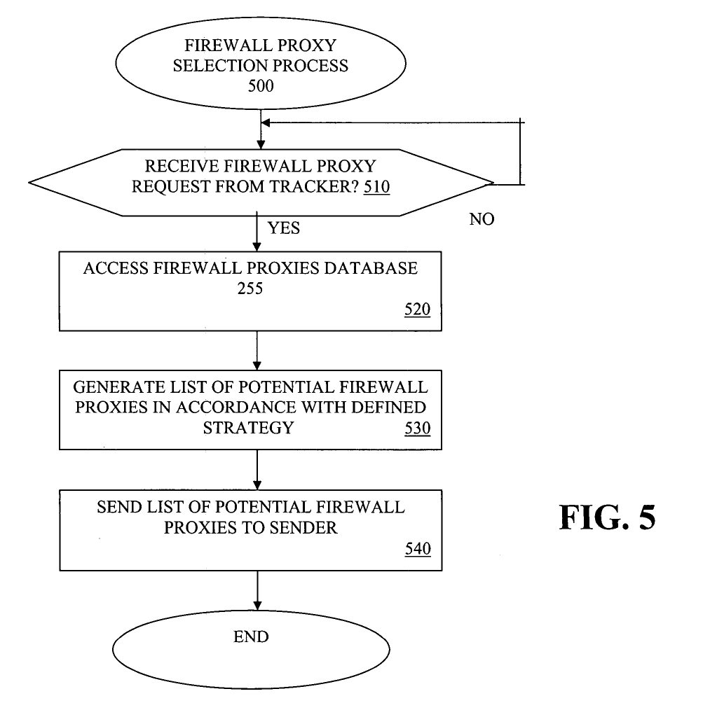

As shown in FIG. 3, if the communication sequence 300 resumes following execution of the bit torrent initiation process 400, the firewall routing tracker 230 sends a request during step 335 to the proxy service 250 for a list of potential firewall proxies 260. Upon receipt of the firewall proxy request 335, the proxy service 250 will initiate a firewall proxy selection process 500, as discussed further below in conjunction with FIG. 5. Generally, the firewall proxy selection process 500 generates a list of potential firewall proxies.

As shown in FIG. 3, the proxy service 250 sends the generated list of potential firewall proxies to the sender 210 during step 340. The sender 210 processes the list of potential firewall proxies during step 345 to obtain the necessary number of firewall proxies. For example, the list may comprise 15 potential firewall proxies and the sender 210 may sequentially contact potential firewall proxies until 10 firewall proxies have agreed to participate. If the sender 210 is unable to obtain a sufficient number of firewall proxies 260 from the list of potential firewall proxies provided during step 340, the sender can request another list of potential proxies from the proxy service 250.

It is noted that the communication between the sender 210 and firewall proxies 260 is only shown for one exemplary firewall proxy 260. It is further noted that by having the sender 210 process the list of potential firewall proxies during step 345, the load is reduced on the central firewall routing tracker 230, allowing improved scaling as the number of users increases.

Thus, the sender 210 sends an “ask” message to a potential firewall proxy 260 during step 350, whereby the sender 210 asks the firewall proxy to serve as a proxy for a given piece of the file 205. The request contains an identifier of the torrent and file piece and the address of the firewall routing tracker 230.

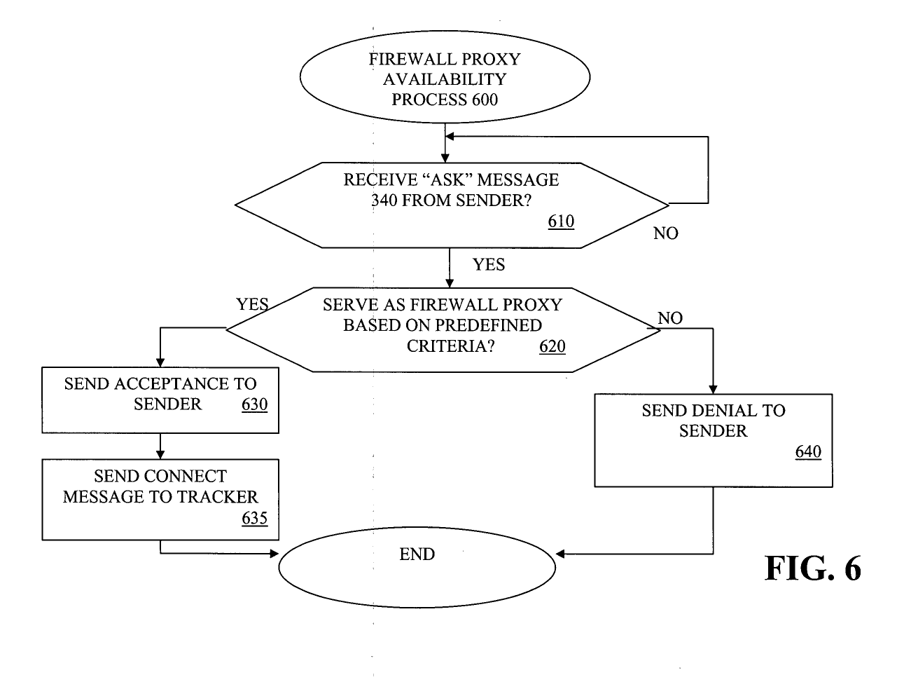

The “ask” message is received and processed by the firewall proxy 260 using a firewall proxy availability process 600, as discussed further below in conjunction with FIG. 6. Generally, the firewall proxy availability process 600 processes the “ask” request and determines whether to accept the request. If the potential node can serve as a firewall proxy, the sender 210 will receive an acceptance message during step 355.

In addition, if the potential node can serve as a firewall proxy, the node 260 will send a connect message to the firewall routing tracker 230 during step 357 indicating that the node will serve as a firewall proxy for an identified piece of the torrent. The firewall routing tracker 230 will process the connect message during step 360 and trigger notification messages sent to the sender 210 and receiver 220 during steps 365, 372, respectively. The notification messages identify the firewall proxy 260 for the piece.

The sender 210 will initiate a process 358 to process the acceptance message 355 from the firewall proxy 260 and the notification message 365 from the firewall routing tracker 230, and generate a BitTorrent send piece message during step 370, in order to send the appropriate piece of the file 205 to the firewall proxy 260. In one exemplary implementation, the piece is encrypted using the key in the extended .torrent file to preserve the security of the file. It is noted that in most applications, encryption is preferable even though each firewall proxy 260 only has access to a small portion of the file.

In response to receiving the notify message from the tracker 230 during step 373, the receiver 220 will send BitTorrent handshake and request piece messages 382, 384, in a known manner, in order to negotiate and obtain the appropriate piece of the file 205 from the firewall proxy 260-n. In addition, the firewall proxy 260-n will process the request from the receiver 220 during step 375 and return the requested piece during step 390. In addition, the firewall proxy 260-n validates the content and sends a confirmation message during step 398 to the sender 210 indicating that the firewall proxy 260 has the piece.

FIG. 4 is a flow chart describing an exemplary implementation of a bit torrent initiation process 400, as performed by the firewall routing tracker 230. As indicated above and shown in FIG. 4, the bit torrent initiation process 400 is initiated during step 410 upon receipt of a seed connection request 310 from a sender 210. Upon receipt of the seed connection request 310, the bit torrent initiation process 400 determines if the receiver 220 is online during step 420. If it is determined during step 420 that the receiver 220 is not online, then the file can be sent to the receiver 220 during step 430 using offline routing techniques during step 430, as described in U.S. patent application Ser. No. ______, filed contemporaneously herewith and entitled “Method And Apparatus For Offline Cooperative File Distribution Using Cache Nodes.”

If, however, it is determined during step 420 that the receiver 220 is online, then a further test is performed during step 440 to determine if the sender 210 and receiver 220 are both behind firewalls 215. If it is determined during step 430 that at least one of the sender 210 and receiver 220 are not behind a firewall 215, then the sender 210 and receiver 220 can communicate directly, and the file may be shared during step 450 using conventional BitTorrent techniques.

If, however, it is determined during step 440 that the sender 210 and receiver 220 are both behind firewalls 215, then a further test is performed during step 460 to determine if the sender 210 and receiver 220 can communicate around the firewall(s) 215 (also shown as step 330 in FIG. 3), for example, using known User Datagram Protocol (UDP) hole punching techniques. If it is determined during step 460 that the sender 210 and receiver 220 can communicate around the firewall(s) 215, then the sender 210 and receiver 220 can communicate directly, and the file may be shared during step 450 using conventional BitTorrent techniques.

If, however, it is determined during step 460 that the sender 210 and receiver 220 cannot communicate around the firewall(s) 215, then the file is sent during step 470 using the firewall routing techniques of the present invention, by sending a request to the proxy service 250 for a list of potential firewall proxies. Generally, the firewall routing techniques of the present invention assume that both the sender 210 and receiver 220 are both online and behind firewalls 215.

FIG. 5 is a flow chart describing an exemplary implementation of a firewall proxy selection process 500, as performed by the proxy service 250. As indicated above and shown in FIG. 5, the firewall proxy selection process 500 is initiated during step 510 upon receipt of a firewall proxy request 335 from the firewall routing tracker 230.

The firewall proxy selection process 500 accesses the firewall proxies database 255 during step 520 to generate a list of potential firewall proxies 260 during step 530. The generated list is then sent to the sender 210 during step 540 (corresponds to step 340 in FIG. 3). Generally, the firewall proxy selection process 500 selects potential firewall proxies 260 that are not behind a firewall, and satisfy one or more resource criteria, such as having generally high measures for idleness, available disk space, available bandwidth, and the likelihood that the node is online.

FIG. 6 is a flow chart describing an exemplary implementation of a firewall proxy availability process 600 that is implemented by a potential firewall proxy 260 and incorporates features of the present invention. As shown in FIG. 6, the firewall proxy availability process 600 is initiated during step 610 upon receipt of an “ask” message from a sender 210. Generally, the firewall proxy availability process 600 processes the “ask” request and determines whether to accept the request during step 620 using predefined resource criteria. For example, one or more thresholds may be established that prevent a node from serving as a firewall proxy if the node does not have sufficient available capacity or idle time, or the percentage of work being performed by the node for the cooperative file distribution system 200 exceeds a predefined threshold.

If the node can serve as a firewall proxy, an acceptance message is sent to the sender 210 during step 630 (step 355 in FIG. 3) and a connect message is sent to the firewall routing tracker 230 during step 635 (step 357 in FIG. 3) indicating that the node will serve as a firewall proxy for an identified piece of the torrent. If the node cannot serve as a firewall proxy, a denial message is sent to the sender 210 during step 640 (not shown in FIG. 3). As indicated above, if the sender 210 is unable to obtain a sufficient number of firewall proxies 260 from the list of potential firewall proxies provided during step 340, the sender can request another list of potential proxies from the proxy service 250.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A cooperative method for transferring a file from a sender to a receiver, comprising:
receiving an indication from said sender that said sender has said file;
determining if both said sender and receiver are behind a firewall;
obtaining a list of potential firewall proxies for transferring said file from said sender to said receiver; and
initiating a transfer of said file from said sender to said receiver using one or more of said potential firewall proxies.

2. The method of claim 1, further comprising the step of determining if said sender and receiver can communicate around said firewalls.

3. The method of claim 1, wherein each of said firewall proxies on said potential list of firewall proxies are not behind a firewall and satisfy one or more predefined resource criteria.

4. The method of claim 1, further comprising the step of determining if one or more of said firewall proxies on said potential list of firewall proxies agree to serve as a firewall proxy.

5. The method of claim 4, wherein a given firewall proxy determines whether to serve as a firewall proxy for a given communication by comparing one or more resource measures to predefined criteria.

6. A cooperative method for sending a file from a sender to a receiver, comprising:
sending an indication to a central tracker that said sender has said file;
receiving a list of potential firewall proxies for transferring said file to said receiver;
sending a request to one or more of said firewall proxies from said list of firewall proxies to act as a firewall proxy between said sender and said receiver; and
transferring said file from said sender to said one or more of said potential firewall proxies.

7. The method of claim 6, further comprising the step of determining if said sender and receiver can communicate around one or more firewalls.

8. The method of claim 6, wherein each of said firewall proxies on said potential list of firewall proxies are not behind a firewall and satisfy one or more predefined resource criteria.

9. The method of claim 6, further comprising the step of determining if one or more of said firewall proxies on said potential list of firewall proxies agree to serve as a firewall proxy.

10. The method of claim 9, wherein a given firewall proxy determines whether to serve as a firewall proxy for a given communication by comparing one or more resource measures to predefined criteria.

11. A method for identifying one or more firewall proxies for transferring a file from a sender to a receiver, comprising:
identifying one or more firewall proxies that are not behind a firewall and satisfy one or more predefined resource criteria; and
providing a list of potential firewall proxies for transferring said file from said sender to said receiver.

12. The method of claim 11, wherein said predefined resource criteria evaluates measures for one or more of idleness, disk space, bandwidth, and network persistence

13. A cooperative method for sending a file from a sender to a receiver, comprising:
receiving a request to act as a firewall proxy between said sender and said receiver;
comparing one or more resource measures to predefined criteria; and
providing an acceptance to said sender if said one or more resource measures satisfy said predefined criteria.

14. The method of claim 13, wherein said resource measures include one or more of capacity, idle time, or a percentage of work being performed as a firewall proxy for other communications.

15. A cooperative method for receiving a file from a sender behind a firewall, comprising:
sending a connection message to a central tracker to obtain said file;
receiving a notification of one or more firewall proxies storing at least a portion of said file; and
obtaining said at least a portion of said file from said one or more firewall proxies.

16. The method of claim 15, further comprising the step of determining if said sender and receiver can communicate around one or more firewalls.

17. A cooperative system for transferring a file from a sender to a receiver, comprising:
a memory; and
at least one processor, coupled to the memory, operative to:
receive an indication from said sender that said sender has said file;
determine if both said sender and receiver are behind a firewall;
obtain a list of potential firewall proxies for transferring said file from said sender to said receiver; and
initiate a transfer of said file from said sender to said receiver using one or more of said potential firewall proxies.

18. A cooperative system for sending a file from a sender to a receiver, comprising:
a memory; and
at least one processor, coupled to the memory, operative to:
send an indication to a central tracker that said sender has said file;
receive a list of potential firewall proxies for transferring said file to said receiver;
send a request to one or more of said firewall proxies from said list of firewall proxies to act as a firewall proxy between said sender and said receiver; and
transfer said file from said sender to said one or more of said potential firewall proxies.

19. A system for identifying one or more firewall proxies for transferring a file from a sender to a receiver, comprising:
a memory; and
at least one processor, coupled to the memory, operative to:
identify one or more firewall proxies that are not behind a firewall and satisfy one or more predefined resource criteria; and
provide a list of potential firewall proxies for transferring said file from said sender to said receiver.

20. A cooperative system for sending a file from a sender to a receiver, comprising:
a memory; and
at least one processor, coupled to the memory, operative to:
receive a request to act as a firewall proxy between said sender and said receiver;
compare one or more resource measures to predefined criteria; and
provide an acceptance to said sender if said one or more resource measures satisfy said predefined criteria.

21. A cooperative system for receiving a file from a sender behind a firewall, comprising:
a memory; and
at least one processor, coupled to the memory, operative to:
send a connection message to a central tracker to obtain said file;
receive a notification of one or more firewall proxies storing at least a portion of said file; and
obtain said at least a portion of said file from said one or more firewall proxies.
